(19) United States
(12) Patent Application Publication
(10) Pub. No.: US 2012/0164342 A1
(43) Pub. Date: Jun. 28, 2012

(54) METHOD FOR REMOVING IMPURITIES FROM PLATING SOLUTION

(75) Inventor: Yoshiyuki HAKIRI, Niigata-shi (JP)

(73) Assignee: Rohm and Haas Electronic Materials LLC, Marlborough, MA (US)

(21) Appl. No.: 13/338,642

(22) Filed: Dec. 28, 2011

(30) Foreign Application Priority Data
Dec. 28, 2010 (JP) 2010-292157

(51) Int. Cl. B05D 1/18; C23C 18/31

(52) U.S. Cl. 427/437; 106/1.22

(57) ABSTRACT

A method of regenerating an electroless tin or tin alloy plating solution containing thiourea or thiourea compounds by reducing impurities by adding organosulfonic acid, organosulfonic acid compound, or salts thereof in certain amounts and then cooling the solution to form precipitates. The precipitates are then removed from the tin or tin alloy solution.

### FIELD OF THE INVENTION

The present invention is directed to a method of removing impurities from an electroless tin or tin alloy plating solution containing thiourea compounds. More specifically, the present invention is directed to a method of removing impurities from an electroless tin or tin alloy plating solution containing thiourea compounds by adding organosulfonic acid compounds to the electroless tin plating solution and adjusting the solution temperature to form a precipitate.

### BACKGROUND OF THE INVENTION

In recent years electroless tin plating has been used for plating machine parts, flexible boards and printed wiring boards and circuit patterns for electronic parts. These electroless tin platings are often used as displacement tin plating on copper or copper alloys. As displacement tin plating on copper or copper alloys is continued the substituted copper becomes copper alloys which dissolve in the plating bath. Copper ions accumulate in the plating bath as the plating progresses. These accumulated copper ions make the plating films worse and lower the performance of the bath. Accordingly, the bath needs to be renewed.

Batch method and feed-and-bleed method are known as methods for managing plating solutions. The batch method is one in which a new plating bath is renewed when the bath deteriorates. In electroless tin plating the bath must be renewed whenever the copper ion concentration rises and the performance of the bath is lowered. In general, electroless tin plating baths have problems of an increased number of remaking operations, lowered productivity and increased processing cost of the waste baths. Moreover, the feed-and-bleed method is one in which the plating continues while the plating solution overflows. The copper ions can be removed from the system by the overflow without stopping the plating operation, but a large quantity of plating solution must be replenished, and this indeed requires an increase in cost.

Several methods have been proposed to solve these problems. For example, in JP05222540A, part of the plating solution is taken out, copper-thiourea complex in the bath is precipitated by cooling, and the copper-thiourea complex is removed by filtration. The filtrate is then returned to the plating tank. Another method is described in JP2002317275A in which the same operations are performed as in JP05222540A. The copper-thiourea complex is precipitated by cooling the plating solution to 40° C. or lower, and this is filtered and removed.

A further method is described in JP10317154A in which regenerating cells provided with a positive electrode, a negative electrode, and cation and anion exchange membranes are provided. In the regenerating cells the copper is electrodeposited on the positive electrode and the tin ions which pass through the cation exchange membrane are added to the plating solution after being electrolyzed and returned to the plating tank. Furthermore, a method is described in JP04276082A in which the copper-thiourea complex is oxidized and decomposed.

However, the inventors' research has shown that the removal of the copper by the processes of JP05222540A and JP2002317275A is insufficient. Therefore, a method of removing copper to lower concentrations is needed. The method of JP10317154A requires a regeneration electrolysis cell and the mechanism is complex. Moreover, the method described in JP04276082A requires a reagent and apparatus for oxidizing and decomposing the copper-thiourea complex. Accordingly, there is still a need for a method of removing copper ions from electroless tin plating solutions.

### SUMMARY OF THE INVENTION

Methods for removing impurities from a tin or tin alloy plating solution include providing a tin or tin alloy plating solution including one or more sources of tin ions, thiourea or thiourea compounds; adding an organosulfonic acid, organosulfonic acid compound, or salts thereof to the tin or tin alloy plating solution; and cooling the tin or tin alloy plating solution to form a precipitate.

The electroless tin or tin alloy plating solutions which include one or more sources of tin ions, thiourea or thiourea compounds can be regenerated by adding an organosulfonic acid, organosulfonic acid compound, or salts thereof in the electroless tin or tin alloy plating solution and cooling the solution to generate a precipitate after conducting electroless plating on copper or a copper alloy by using the electroless plating solution, then removing the precipitate from the solution.

The electroless tin or tin alloy plating solution can be used to form a tin or tin alloy plating film by circulating a part or all of the plating solution in a plating tank through a separation unit and filtering a precipitate generated in the tank by a separation unit after adding organosulfonic acid, organosulfonic acid compound, or salts thereof in the plating solution and cooling the solution to generate the precipitate.

The methods of electroless tin or tin alloy plating may include the use of a multiple tank plating device having a main tank to plate the material, a precipitation tank having a cooling system to generate a precipitate, circulation pipes connected between the main tank and the precipitation tank capable of circulating the electroless tin or tin alloy plating solution, and a solid-liquid separation unit placed between the precipitation tank and the main tank such that the method includes the steps of adding organosulfonic acid, organosulfonic acid compound, or salts thereof to the plating solution in the precipitation tank, cooling the plating solution in the precipitation tank, and separating a solid in the solution generated in the precipitation tank using the solid-liquid separation unit.

Electroless tin and tin alloy plating can be done using a single tank plating device having a plating tank to plate a material, circulation pipes connected to the plating tank capable of circulating a part or all of the plating solution, a solid-liquid separation unit placed in the circulation route of the plating solution, and a thermal control system to cool or warm the plating solution in the plating tank. Such a method includes contacting the material to be plated with the electroless tin or tin alloy plating solution in the plating tank, adding organosulfonic acid, organosulfonic acid compound, or salts thereof to the plating solution in the plating tank, cooling the plating solution to form a precipitate, and circulating and removing the precipitate generated in the bath using the solid-liquid separation unit.

The addition of organosulfonic acid, organosulfonic acid compound, or salts thereof in the electroless tin or tin alloy plating solution and cooling the bath to generate a precipitate enables control over the electroless tin or tin alloy plating solution during plating on copper and copper alloys.

The methods enable the removal of impurities in tin and tin alloy electroless plating solutions at lower concentrations than in conventional methods without requiring special apparatus for removing the solution impurities.

### DETAILED DESCRIPTION OF THE INVENTION

As used throughout this specification, the following abbreviations shall have the following meanings, unless the context indicates otherwise: ° C.=degrees Centigrade, g=grams, L=liters, ml=milliliters, dm=decimeters, μm=microns or micrometers and SEM=scanning electron microscope. Unless otherwise specified all of the quantities are weight percentage. “Plating solution” and “plating bath” have the same meaning and are used interchangeably.

The inventors performed diligent investigations to solve the impurities problem in electroless tin and tin alloy plating solutions. They discovered that the concentrations of impurities in the bath can be lowered still more than was possible with earlier methods by raising the organosulfonic acid ingredient concentration in electroless tin and tin alloy plating baths temporarily and then cooling it. Thus they perfected this invention.

Impurities in tin and tin alloy plating solutions can be reduced to lower concentrations than was possible with prior methods by using the methods of this invention and without requiring a special apparatus for oxidation and decomposition. Organic acids which are typically included in tin and tin alloy electroless plating baths may be replaced with one or more of the organicsulfonic acids or salts thereof, thus special compounds are not needed as precipitating agents for removing impurities and the adding of the organosulfonic acids or salts thereof may also substitute as the replenishing agents of conventional organic acids typically included in electroless baths. Furthermore, since the plating solution can be reused after the precipitate is removed, the number of times the plating solution is discarded and a new bath is made can be greatly decreased. This contributes greatly to improving industrial productivity.

The plating solution is an electroless tin or tin alloy plating solution. It is a plating solution which can be used for displacement tin or tin alloy plating on copper or copper alloys. Other metal ingredients besides tin may be included in the aforementioned electroless tin plating solution. The aforementioned electroless tin plating solution contains water-soluble tin salts or water-soluble tin salts and other metal salts as sources of tin ions and other metal ions, and thiourea or thiourea compounds as complexing agents.

Any water-soluble tin salt which dissolves in the solution can be used in the aforementioned electroless tin plating solution. For example, one can use stannous sulfate, stannous chloride, stannous fluoroborate, tin alkane sulfonates, and tin alkanol sulfonates.

Moreover, examples of other meal salts which can be used together with the water-soluble tin salts are salts of lead, copper, silver, bismuth or cobalt. Specific examples of these include lead chloride, lead acetate, lead alkane sulfonates, copper chloride, silver nitrate, bismuth chloride and cobalt sulfate.

The total amount of the tin and metal ingredients other than tin in the plating solution is ordinarily in the range of 10-10 g/L, preferably 30-50 g/L, as metal ions.

Acids may be added to the electroless tin plating solution in order to dissolve the tin or other metal ingredients besides tin. Examples of the acids which can be used include sulfuric acid, hydrochloric acid, alkane sulfonic acids, alkanol sulfonic acids and aromatic sulfonic acid. These acids may be used individually or in combinations of two or more. The total amount of the acids added to the plating solution is ordinarily in the range of 1-300 g/L, preferably 50-100 g/L.

The electroless tin or tin alloy plating solution used in this invention includes thiourea or thiourea compounds. They act as complexing agents of the copper ions. From an electrochemical point of view, they are well known to members of this industry as ingredients which make possible displacement tin or tin alloy plating on copper or copper alloys, which cannot be done theoretically, with respect to standard electrode potentials. The thiourea used can be thiourea which is ordinarily obtainable. One can also use commercial thiourea.

The thiourea compounds are derivatives of thiourea. Specific examples include 1-methylthiourea, 1,3-dimethyl-2-thiourea, trimethylthiourea, diethylthiourea, N,N-diisopropylthiourea, 1-(3-hydroxypropyl)-2-thiourea, 1-methyl-3-(3-hydroxypropyl)-2-thiourea, 1-methyl-3-(3-methoxypropyl)-2-thiourea, 1,3-bis(3-hydroxypropyl)-2-thiourea, allylthiourea, 1-actyl-2-thiourea, 1-phenyl-3-(2-thiazolyethiourea, benzylisothiourea hydrochloride, 1-allyl-2-thiourea and 1-benzoyl-2-thiourea. The aforementioned thiourea or thiourea compounds can be used individually or in combinations of two or more. The amount of the compounds is ordinarily in the range of 50-250 g/L, preferably 100-200 g/L.

The electroless tin or tin alloy plating solution may further include, but is not limited to, antioxidants and surfactants, if desired, besides the aforementioned ingredients. Examples of the antioxidants include catechol, hydroquinone, and hypophosphorous acid, and examples of the surfactants are one or two or more cationic, anionic, nonionic, and amphoteric surfactants.

Displacement or electroless tin plating is ordinarily performed by making the plating solution and regulating the temperature in the range of 50-75° C., after which the object to be plated, which has copper or a copper alloy on its surface, is immersed in the plating solution for 120-300 seconds. The tin is substituted for the copper on the surface of the object being plated, becoming a tin film, and copper is dissolved in the plating solution in place of the tin ions. Therefore, the tin is reduced as the plating proceeds. Moreover, while not being bound by theory, the thiourea or thiourea complexing agent is thought to form a complex with the copper ions in the copper solution, and the thiourea or thiourea compounds are also reduced as the plating proceeds. Moreover, the acid and other ingredients are reduced or drawn out as the object being plated is pulled up, and are also reduced as the plating proceeds. These ingredients which are reduced in the plating solution as the plating proceeds are replenished as needed. However, the copper increases as the plating proceeds and accumulates in the bath; therefore the plating film worsens or the performance of the bath is lowered.

This invention is characterized by the fact that an organosulfonic acid, organosulfonic acid compound, or salts of these, referred to below simply as “organosulfonic acid”, are added to the electroless tin plating solution and it is then cooled, producing a precipitate which contains copper, and suppressing the accumulation of copper in the plating solution. By adding the organosulfonic acid to the plating solution and then cooling the plating solution, the copper ion complex dissolved in the plating solution is caused to precipitate and the copper ion concentration in the plating solution can be reduced. The copper ion concentration in the plating solution after the precipitate production is much lower than in the conventional methods. The details of the reaction mechanism are unknown, but, while not being bound by theory, it is thought that the copper ions in the plating solution are present as a thiourea or thiourea compound complex, and by adding the organosulfonic acid, the solubility of the thiourea or thiourea compound complex at low temperatures is reduced, thus forming the precipitate. The solubility of the thiourea or thiourea compound complexes does not change very much if the organosulfonic acid is added at high temperatures, but their solubility at low temperatures is much lower than in the case in which it is not added.

Examples of the organosulfonic acids which can be used are alkanesulfonic acids, alkanolsulfonic acids and aromatic sulfonic acids. Specific examples of these are alkanesulfonic acids of linear alkyl groups, such as methanesulfonic acid, ethanesulfonic acid, propanesulfonic acid, and butanesulfonic acid; alkanesulfonic acids of branched alkyl groups such as isopropylsulfonic acid, and tert-butylsulfonic acid; alkanolsulfonic acids, such as 2-hydroxyethane-1-sulfonic acid, and 2-hydroxypropane-1-sulfonic acid; and aromatic sulfonic acids, such as phenolsulfonic acid, benzenesulfonic acid, toluenesulfonic acid, and naphthaenesulfonic acid. The organosulfonic acid compounds include, but are not limited to, hydrates of the aforementioned organosulfonic acids. Moreover, the salts of the organosulfonic acids and organosulfonic acid compounds may be any desired salts, e.g., sodium, potassium and ammonium salts of the aforementioned organosulfonic acids and organosulfonic acid compounds. The organosulfonic acids, organosulfonic acid compounds, or their salts may be used as mixtures. The amounts in which they are used are ordinarily in the range of 20-500 g/L, preferably 50-400 g/L. If the amount used is small, efficient precipitate formation cannot be performed. Even if the amount used is large, the effect is not changed; therefore, this is not economical. The temperature of the plating solution when it is cooled to form the precipitate is in the range of 5-30° C., preferably 10-20° C.

A first method is a method for removing impurities from a tin plating solution comprising thiourea or thiourea compound, wherein adding an organosulfonic acid, organosulfonic acid compound, or salts thereof in the tin or tin alloy plating solution and cooling the solution to generate a precipitate. Here, it is desirable for the tin or tin alloy plating solution to which the organosulfonic acid is added be one which has already been used in electroless tin plating. In this case, if it is a solution which has been used in electroless plating, the electroless plating treatment may have been completed, or it may be at the stage of being performed. As impurities, it may contain copper eluted from the object being plated or other metals, such as nickel, zinc, chromium, molybdenum, and tungsten. The impurity is especially copper. The copper can be effectively removed from the plating solution. As mentioned above, when the organosulfonic acid is added to the plating solution which has been used in plating and which has an increased copper concentration, and the plating solution is cooled after it has been added, the undissolved ingredient precipitates. The copper can be removed from the plating solution by removing this undissolved ingredient. The undissolved ingredient can be removed by using any desired method, for example, filtering using a filter, settling separation and centrifugal separation. The temperature of the plating solution when it has been cooled is as mentioned above.

A second method is a method for regenerating an electroless tin or tin alloy plating solution comprising thiourea or thiourea compounds, wherein adding an organosulfonic acid, organosulfonic acid compound, or salts thereof in the electroless tin plating solution and cooling the solution to generate a precipitate after conducting electroless plating on copper or a copper alloy by using the electroless plating solution, then removing the precipitate from the solution. As mentioned above, the impurities, especially copper, can be removed from the plating solution by adding the organosulfonic acid and then cooling the solution and removing the precipitate produced. The plating solution can be reused after the precipitate has been removed, and one can continue to use it as a plating solution by supplementing the other ingredients which have been consumed or reduced. Therefore, it is not necessary to dispose of aged plating solutions, and the industrial productivity can be increased.

A third method is a method for forming a tin or tin alloy plating film using an electroless tin or tin alloy plating solution comprising thiourea or a thiourea compound, by circulating a part or all of the plating solution in a plating tank through a separation unit and filtrating by the separation unit a precipitate generated in the tank, after adding organosulfonic acid, organosulfonic acid compound, or salts thereof in the plating solution and cooling the solution to generate a precipitate. In this method, it is desirable to recycle the electroless tin plating solution after the plating operation has been temporarily stopped. Moreover, it is also desirable to add the organosulfonic acid when the plating operation is temporarily stopped. The consumed or reduced necessary ingredients of the plating solution are replenished after the cooling and precipitate removal have been performed, and the plating solution is heated to a temperature suitable for plating, after which the plating is restarted. The undissolved ingredient can be removed by using any desired method, for example, filtering using a filter, settling separation, and centrifugal separation. Here, it is desirable to add the organosulfonic acid to a plating solution which has deteriorated due to the plate operation, that is, in the course of plating the object to be plated, when, for example, copper, nickel, zinc, chromium, molybdenum, or tungsten, have eluted from the object being plated and the performance of the bath has fallen. As mentioned above, the formation of the plating film is performed by making the plating solution and regulating the temperature in the range of 50-75° C., after which the object to be plated, which has copper or a copper alloy on its surface, is immersed in the plating solution for 120-300 seconds. Since the copper ions are eluted in the plating solution as the plating proceeds, the addition of the organosulfur solution, the cooling and circulation of the plating solution, and the capturing and removal of the precipitate may be performed with the necessary timing.

A fourth method is a method for electroless plating of material to be plated using a tin or tin alloy plating solution comprising thiourea or a thiourea compound with use of a multiple tank plating device having a main tank to plate the material, a precipitation tank having a cooling system to generate a precipitate, circulation pipes connected between the main tank and the precipitation tank capable of circulating electroless plating solution, and a solid-liquid separation unit placed between the precipitation tank and the main tank. The method includes the steps of; adding organosulfonic acid, organosulfonic acid compound, or salts thereof to the plating solution in the precipitation tank, cooling the plating solution in the precipitation tank, and separating a solid in the solution generated in the precipitation tank using the solid-liquid separation unit. The fourth method is characterized by the fact that a multiple-tank plating device is used which is provided with a precipitation tank for forming the precipitate in addition to the main tank, in which the electroless plating is performed. At least two tanks are necessary, but if necessary three or more tanks may be used. Since the plating treatment and the formation of the precipitate can be performed in the main and precipitation tanks, respectively, one can use tanks of any desired size and shape. It is desirable to place thermal control systems in the main and precipitation tanks. In the main tank heating is primarily performed and cooling is primarily performed in the precipitation tank. The main and precipitation tanks are connected by pipes such that the electroless plating solution can be circulated. The pipes can be of any desired form as long as the plating solution can be circulated. Moreover, the solid-liquid separation unit is placed between the precipitation tank and the main tank, and the precipitate which is produced by cooling the plating solution after the organosulfonic acid is added can be separated. As mentioned above, the solid-liquid separation unit may be any desired one.

In the first step, the organosulfonic acid is added to the plating solution in the precipitation tank. In the fourth method the addition of the organosulfonic acid may be performed while the plating operation is continuing in the main tank; thus, it is advantageous in that it is not necessary to stop the plating operation. The temperature of the plating solution in the main tank is preferably in the range of 50-75° C., and the temperature of the plating solution in the precipitation tank is preferably in the range of 5-30° C. In the third step, the method of capturing the precipitate that is produced by using a solid-liquid separation unit is the same as described above.

A fifth method is a method for electroless plating of material to be plated using a tin or tin alloy plating solution comprising thiourea or thiourea compounds with use of a single tank plating device having a plating tank to plate a material, circulation pipes connected to the plating tank capable of circulating a part or all of the plating solution, a solid-liquid separation unit placed in the circulation route of the plating solution, and a thermal control system to cool or warm the plating solution in the plating tank. The method includes the steps of contacting the material to be plated with the plating solution in the plating tank, adding organosulfonic acid, organosulfonic acid compound, or salts thereof to the plating solution in the plating tank cooling the plating solution to precipitate a precipitation, and circulating and removing the precipitate generated in the bath using the solid-liquid separation unit. The fifth method is characterized by the fact that a single-tank plating device is used to produce a precipitate by adding an organosulfonic acid to the plating tank in which the electroless plating is performed. The plating tank may be any size and shape in which the plating treatment and precipitation formation can take place. The thermal control system may be of any desired form as long as the plating solution can be controlled at the desired temperature. As mentioned above, the circulation pipes and the solid-liquid separation unit may be of any desired form.

In the first step, the object to be plated is immersed in the plating solution in the plating tank and the displacement plating is performed. The temperature of the plating solution in the main tank is preferably in the range of 50-75° C. As the displacement plating proceeds in the plating tank, the copper ions dissolved from the object being plated accumulate in the plating solution. In the second step, the organosulfonic acid, organosulfonic acid compound, or a salt thereof, is added to the plating solution in the plating tank. In the fifth step the plating operation in the plating tank may be continued when the organosulfonic acid is added or the plating operation may be stopped temporarily. In the third step, the plating solution in the plating tank, to which the organosulfonic acid has been added, is cooled. The temperature of the plating solution in the plating tank when the cooling is performed is preferably in the range of 50-75° C., as mentioned above. When the third step is performed, it is necessary to stop the plating operation, since the plating temperature becomes lower than the range suitable for plating. In the fourth step, the precipitate produced in the plating tank is carried to the solid-liquid separation unit by way of the circulating pipe and it is separated and removed from the plating solution. The circulation of the plating solution must be performed at least after the organosulfonic acid has been added. Moreover, if the aforementioned first to fourth steps are started in that order, they can be performed by going to the next step without waiting for the preceding step to be completed. For example, the addition of the organosulfonic acid, which is the second step, can be performed either after the object to be plated has been immersed in the plating solution in the plating tank, which is the first step, or it can be performed while the immersion of the object to be plated is continued.

A sixth method is a method for control over an electroless tin or tin alloy plating solution comprising thiourea or thiourea compound for plating copper or a copper alloy, where adding organosulfonic acid, organosulfonic acid compound, or salts thereof in the plating solution and cooling the bath to generate a precipitate to decrease the concentration of copper ions in the plating solution. In a plating tank of one of the various forms mentioned above, the copper ion concentration in the plating solution is measured and the organosulfonic acid is added to the plating solution at a suitable time before the copper ion concentration reaches the upper limit which causes a bad effect on the plating. Next, the plating solution to which the organosulfonic acid has been added is cooled and a precipitate is produced, thus reducing the copper ion concentration in the plating solution. Thus, the electroless plating solution can be managed in the optimum state. The copper ions in the plating solution can be measured by selecting a suitable method, for example, drawing part of the plating solution and measuring the copper ion concentration by atomic absorption or ICP.

The following examples are included to illustrate the invention but are not intended to limit the scope of the invention.

### Working Example 1

An electroless plating solution (basic bath 1) with the following composition was prepared.

### Basic Bath 1

| | |
|---|---|
| Tin borofluoride (as Sn²⁺) | 30 g/L |
| Methanesulfonic acid | 100 g/L |
| Hypophosphorous acid | 15 g/L |
| Thiourea | 100 g/L |
| Nonionic surfactant | 30 g/L |

15 g/L copper powder were added to this tin plating solution and it was heated while stirring to 65° C. for 5 hours completing the copper and tin displacement reaction. In this way a model deteriorated electroless tin plating solution containing copper ions was made. The aforementioned model deteriorated electroless tin plating solution was kept at 65° C. while 50 g/L methanesulfonic acid was added. Then the plating solution was cooled to 15° C. After the plating solution was cooled, a buoyant substance was produced in the plating solution. The buoyant substance was removed by passing the plating solution through a 0.2 micron filter. The copper concentration in the plating solution after the filtration was measured by the atomic absorption method. The copper concentration measured was 4.1 g/L.

### Working Examples 2-3

The same operations were performed as in Working Example 1 except that methanesulfonic acid was added in the quantities shown in Table 1 to the aforementioned basic bath 1. The copper concentration was measured and the measured concentrations are shown in Table 1.

### Comparative Example 1

The same operations were performed as in Working Example 1, except that the methanesulfonic acid was not added.

The results are shown in Table 1.

TABLE 1

| | Quantity of | Copper |
|---|---|---|
| | methanesulfonic | concentration |
| | acid added (g/L) | (g/L) |
| Working Example 1 | 50 | 4.1 |
| Working Example 2 | 100 | 2.5 |
| Working Example 3 | 300 | 1.4 |
| Comparative Example 1 | — | 6.0 |

From these results it can be seen that when the cooling was performed after the methanesulfonic acid was added, the copper concentration in the plating solution was reduced compared with the case in which only the cooling was performed without adding the methanesulfonic acid as in Comparative Example 1.

### Working Examples 4-6 and Comparative Example 2

An electroless plating solution with the following composition (basic bath 2) was prepared, changing the composition of the plating bath from Working Example 1.

### Basic Bath 2

| | |
|---|---|
| Tin borofluoride (as Sn²⁺) | 30 g/L |
| Phenolsulfonic acid | 160 g/L |
| Hypophosphorous acid | 15 g/L |
| Thiourea | 100 g/L |
| Nonionic surfactant | 30 g/L |

The same operations were performed as in Working Example 1, except that the phenolsulfonic acid was added in the quantities shown in Table 2 to the aforementioned basic bath 2. The results are shown in Table 2.

TABLE 2

| | Quantity of | Copper |
|---|---|---|
| | phenolsulfonic acid | concentration |
| | added (g/L) | (g/L) |
| Working Example 4 | 90 | 12.6 |
| Working Example 5 | 160 | 11.1 |
| Working Example 6 | 320 | 7.3 |
| Comparative Example 2 | — | 14.0 |

From these results it can be seen that when the cooling was performed after the phenolsulfonic acid was added the copper concentration in the plating solution was reduced compared with the case in which only the cooling was performed without adding the phenolsulfonic acid as in Comparative Example 2.

### Working Examples 7-9 and Comparative Example 3

A performance verification test was performed on a plating solution after an organosulfonic acid was added and impurities were removed. The basic bath 1 used in Working Example 1 was prepared.

15 g/L copper powder was added to the basic bath 1 mentioned above and it was heated for 5 hours completing the copper and tin displacement reaction. In this way, a model deteriorated electroless tin plating solution containing copper ions was made. Tin borofluoride was added to the aforementioned model deteriorated electroless tin plating solution to replenish the tin which was reduced by the displacement with the copper. The tin concentration was regulated at 30 g/L. Using this plating solution displacement tin plating was performed at 65° C. for 3 minutes and 15 seconds on objects to be plated. A TCP (tape carrier package) and a COF (chip on film), and SEM observations and film thickness measurements were performed. 71 g/L (Working Example 7), 142 g/L (Working Example 8), and 284 g/L (Working Example 9) of methanesulfonic acid were added to these plating solutions, and they were cooled to 15° C. after stirring. Next, filtration was performed removing the precipitate that was produced. After the precipitate was removed the ingredients other than the methanesulfonic acid were replenished to match the composition of basic bath 1. The displacement plating was performed using the respective baths. The film thicknesses were measured and the film thicknesses and the copper concentrations in the plating solutions were compared with Comparative Example 3, in which the methanesulfonic acid was not added. The results are shown in Table 3.

TABLE 3

| | Film | Copper concentration |
|---|---|---|
| | thickness | in plating |
| | (μm) | solution (g/L) |
| Working Example 7 | 0.49 | 2.6 |
| Working Example 8 | 0.51 | 1.3 |
| Working Example 9 | 0.51 | 0.5 |
| Comparative Example 3 | 0.41 | 6.0 |

In Working Examples 7-9 copper removal was performed by using methanesulfonic acid, after which it was verified that the bath performance was restored (the precipitation speed was restored) by replenishing the necessary ingredients.

What is claimed is:

1. A method for removing impurities from a tin or tin alloy plating solution comprising:
a) providing a solution comprising one or more sources of tin ions and thiourea or a thiourea compound;
b) adding an organosulfonic acid, organosulfonic acid compound, or salts thereof in the solution; and
c) cooling the solution to generate a precipitate.

2. The method for removing impurities from a tin or tin alloy plating solution of claim 1, further comprising electrolessly plating tin or tin alloy on copper or copper alloy.

3. The method for removing umpurities from a tin or tin alloy plating solution of claim 2, wherein the electrolessly plating tin or tin alloy on the copper or copper alloy is at a temperature range of 50-75° C.

4. The method for removing impurities from a tin or tin alloy plating solution of claim 1, wherein a part or all of the solution is circulated in a plating tank through a separation unit to filter the precipitate.

5. The method for removing impurities from a tin or tin alloy plating solution of claim 1, wherein the organosulfonic acid, organosulfonic acid compound or salts thereof are in amounts of 20-500 g/L.

6. The method for removing impurities from a tin or tin alloy plating solution of claim 5, wherein the organosulfonic acid, organosulfonic acid compound or salts thereof are in amounts of 50-400 g/L.

7. The method for removing impurities from a tin or tin alloy plating solution of claim 1, wherein a temperature of the solution at cooling is in a range of 5-40° C.

8. The method for removing impurities from a tin or tin alloy plating solution of claim 7, wherein the temperature of the solution at cooling is in the range of 10-20° C.

9. The method for removing impurities from a tin or tin alloy plating solution of claim 1, wherein the precipitate comprises impurities of copper, nickel, zinc, chromium, molybdenum or tungsten.
